(19) United States
(12) Patent Application Publication
(10) Pub. No.: US 2014/0199509 A1
(43) Pub. Date: Jul. 17, 2014

(54) Decoupling Sheet

(71) Applicant: Heinz Dusar, Anhausen (DE)

(72) Inventor: Heinz Dusar, Anhausen (DE)

(21) Appl. No.: 13/645,686

(22) Filed: Jan. 11, 2013

(51) Int. Cl. B32B 5/18

(52) U.S. Cl. CPC B32B 5/18
USPC 428/43; 428/138; 428/91

(57) ABSTRACT

A decoupling sheet as a support for a covering that is to be mounted on a substructure, comprising at least two interconnected layers that include a foil-type bottom layer for disposition on the substructure, and a support layer for receiving the covering. The support layer is disposed on, and connected to, the bottom layer, and is comprised of an open-pore water resistant, and non-deformable foam material that is provided with apertures that extend from the bottom layer to the opposite, free surface of the foam layer, and which are distributed over the surface of the foam layer.

### The instant application should be granted the priority dates of Oct. 6, 2011 the filing date of the corresponding German patent application 20 2011 051 559.1.

### BACKGROUND OF THE INVENTION

The present invention relates to a decoupling sheet as a support for a covering, such as a ceramic, stone or similar covering, that is to be mounted on a substructure, with the decoupling sheet being comprised of a plurality of interconnected layers.

A decoupling sheet of this type is described in DE 20 2009 001 255 U1 (US 2010/0196658 A1), and is comprised of a layer composite having a total of four layers. The first layer, which is to be mounted on the substructure, for example in the form of a stone floor or wall plaster, is a fleece comprised of polypropylene fibers, upon which is disposed a second layer made of a waterproof foil preferably comprised of polyethylene. Disposed on the polyethylene foil is a 100% polypropylene spacing mesh, which in turn is covered by a covering fleece comprised of polypropylene filaments. Formed in the covering fleece are openings that extend from the surface thereof to the spacing mesh. During installation of the known decoupling sheet, the lowermost layer thereof is glued to the substructure, for example by means of a suitable tile adhesive. To dispose, for example, ceramic tiles upon the uppermost covering fleece layer, a tile adhesive is again distributed over the surface thereof, which only in the region of the openings in the covering fleece penetrates through the covering fleece layer to the spacing mesh, with which it connects in a localized manner, thereby forming beneath the openings in the covering fleece column-like structures having a dimension that corresponds to the height of the spacing mesh. These tile adhesive columns are well anchored in the decoupling sheet by connection to the mesh filaments of the spacing mesh, and ensure in the layer composite, after the curing of the tile adhesive, a good stability for the ceramic tiles, which are uniformly supported on the tile adhesive columns. Between the tile adhesive columns prescribed by the openings, there remains adequate space within the spacing mesh for carrying out a drainage function to the extent that water that penetrates into the decoupling sheet, for example through the tile joints or gaps, collects in the drainage regions of the spacing mesh, and from here can again diffuse back through the tile gaps. Since the waterproof layer is disposed between the substructure and the spacing mesh, the substructure is protected from being affected by the entering water.

However, the known decoupling sheet has the drawback that the multi-layer construction of the decoupling sheet is very complicated to produce, and in addition also requires a great expenditure in material.

It is therefore an object of the present invention to simplify the construction of a decoupling sheet of the aforementioned general type.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective view of a portion of one exemplary embodiment of the decoupling sheet of the present application;

FIG. 2 is an enlarged view of the encircled portion II in FIG. 1, and utilizes a bottom layer that is provided with a fine perforation; and

FIG. 3: is an enlarged view of an alternative embodiment of the encircled portion II in FIG. 1, and utilizes a waterproof foil sheet as the bottom layer.

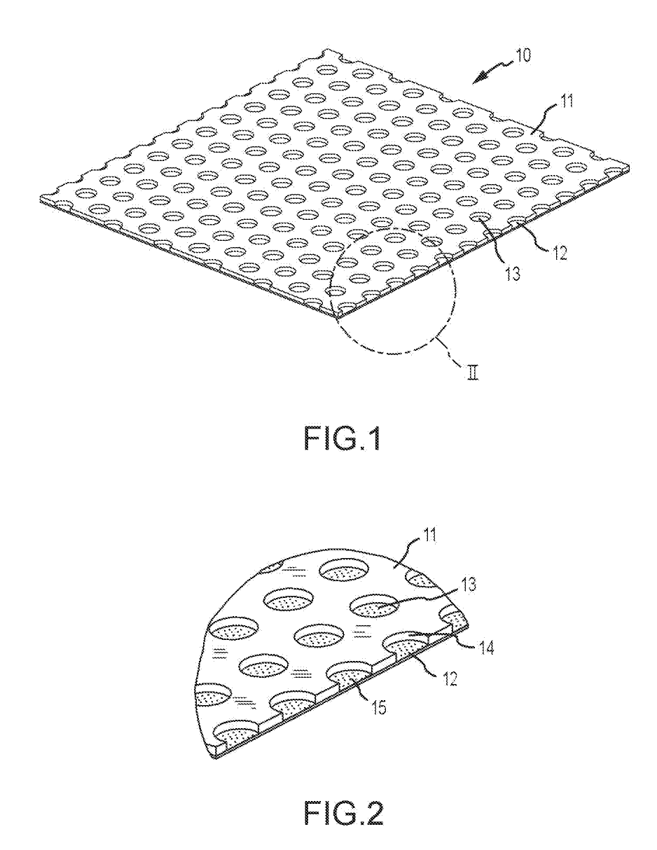

### SUMMARY OF THE INVENTION

The decoupling sheet of the present application is comprised of at least two interconnected layers, including a foil-type sub or bottom layer that is to be disposed on a substructure, and a support layer for receiving the covering, wherein this support layer is disposed upon, and connected to, the bottom layer, and is comprised of an open-pore, water resistant, and non-deformable foam material, in which are disposed apertures that extend from the bottom layer to the opposite, free surface of the foam layer, with these apertures being distributed over the surface of the foam layer.

It has surprisingly been discovered that the conventional tile adhesive which is used in particular for the securement of tiles as ceramic coverings, produces an adequately strong connection with the, in particular open-pored, foam that is used for production of the decoupling sheet of the present invention, so that the construction of the inventive decoupling sheet on the foam layer, and a bottom layer that is connected thereto and is comprised of the waterproof material, can be reduced. This advantageously results in a saving of material, but even more the cost of manufacturing is also reduced. With the decoupling sheet of the present invention, in a manner similar to that described above, the foam layer is to be provided with apertures into which the tile adhesive that is used for the mounting of tiles enters and in doing so also forms tile adhesive columns. However, with the present application due to the open-pore configuration of the walls of the apertures in the foam layer that extend all the way to the bottom layer, in these wall regions of the apertures an adequate connection occurs between the tile adhesive and the foam layer. Thus, the decoupling sheet of the present application also offers the advantage that respective drainage regions remain in the foam layer between the apertures.

It is to be understood that the foam material that is utilized must have an adequate resistance to water as well as an adequate deformability.

Pursuant to a first specific embodiment of the present invention, the bottom layer is provided with a fine perforation. By configuring the bottom layer as a fine-meshed grid or mesh, the tile adhesive that is introduced into the apertures of the foam layer can also additionally produce a connection with the substructure by means of the holes that exist in the bottom layer, so that not only is a direct connection of the tile adhesive columns that support the coverings with the substructure provided via the support layer, which is connected over a large surface with the bottom layer that is mounted on the substructure, but rather there is additionally also provided a direct connection of the tile adhesive columns with the substructure via the perforation that is formed in the bottom layer.

Pursuant to an alternative embodiment, the bottom layer can also be comprised of a waterproof material. In this case, the substructure is kept free of exposure from water or moisture introduced via the tile adhesive, which is advantageous for moisture-sensitive substructures.

Pursuant to a specific embodiment of the present invention, the bottom layer can be comprised of a foil sheet having a sheet of fleece disposed on both sides thereof. With such a construction of the bottom layer, the foil sheet itself can be embodied as a waterproof foil, or in the construction of the bottom layer the appropriate openings or apertures that form the fine-mesh perforation can be introduced. Alternatively, the bottom layer can also be comprised of a sheet of paper, whereby here also the paper sheet can be formed with an appropriate perforation or can also be waterproof.

In the processing of the foam material that is utilized to form such a decoupling sheet, the extrusion process has shown itself to be advantageous, whereby as examples for a suitable foam material, the use of polypropylene, polyethylene, polystyrene or polyurethane is proposed.

Within the framework of the extrusion of the foam layer, pursuant to one specific embodiment of the present invention, the bottom layer is applied to one side of the foam layer in a single working stage during the extrusion of the foam layer.

Further specific features of the present application will be provided in detail subsequently.

### DESCRIPTION OF SPECIFIC EMBODIMENTS

Referring now to the drawings in detail, the decoupling sheet 10 shown in the drawing is comprised of two layers that are connected to one another, namely a support layer in the form of a foam layer 11, which is foamed from an open-pored, and also water resistant or waterproof and non-deformable, foam material, and a sub or bottom layer 12, which is disposed on the underside of the foam layer 11 as viewed in the drawings. At the conclusion of the manufacture of the foam layer 11, the bottom layer 12 can be connected, preferably adhesively, with the foam layer 11.

Introduced into the foam layer 11 are apertures or openings 13, which in the illustrated embodiment are uniformly distributed over the surface of the foam layer. These apertures 13 extend all the way from the free or exposed surface of the foam layer 11 to the bottom layer 12 that is disposed thereon. Thus, each individual aperture 13 has a circumferential wall 14 that is formed from the open-pored foam material of the foam layer 11.

An extrusion of the respectively utilized foam material can preferably be provided for the manufacture of the foam layer 11. In this connection, the apertures 13 can be formed directly in the extrusion process; alternatively, however, the apertures can also be punched or stamped out at the conclusion of the manufacture of the foam layer 11 by means of suitable tools. The bottom layer 12 is either subsequently applied to the foam layer 11, or can even be simultaneously disposed on the foam layer 11 during the extrusion thereof.

During installation of the decoupling sheet 10 of the present application, its bottom layer 12 is placed upon the substructure of the building, and it is optionally connected to the substructure. Depending upon the use or application of the decoupling sheet 10, in certain applications a loose placement upon the substructure is also sufficient. If the decoupling sheet 10 is to be connected to the substructure, various adhesion techniques are available for this purpose. For example, for mounting a fleece covering, a conventional tile adhesive is applied to the free surface of the foam layer 11; this tile adhesive penetrates into the apertures 13, and in the region of the walls 14 connects with the open-pored foam, so that the fleece layer that is adhesively applied by means of the tile adhesive adheres securely to the decoupling sheet 10.

As can be seen in FIG. 2, the bottom layer 12 can be provided with a fine perforation 15, resulting in an additional connection of the tile adhesive, introduced into the apertures 13 via the perforation 15 through the bottom layer 12, with the substructure.

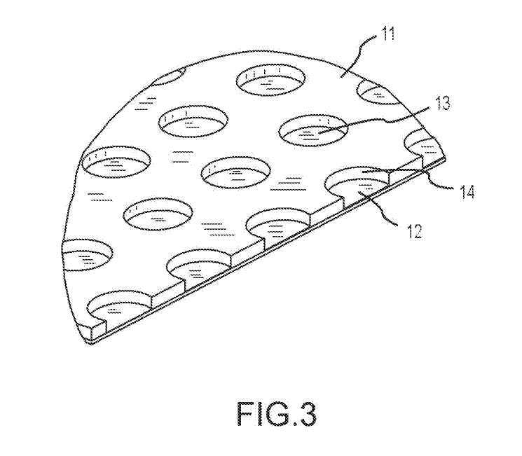

In the embodiment illustrated in FIG. 3, the bottom layer 12 is comprised of a water impervious or waterproof material, for example a waterproof foil of polymeric material.

The features of the subject matter of these documents disclosed in the preceding specification, the claims and the drawings can be important individually as well as in any desired combination with one another for realizing the various embodiments of the invention.

The specification incorporates by reference the disclosure of German priority document filed Oct. 6, 2011.

The present invention is, of course, in no way restricted to the specific disclosure of the specification and drawings, but also encompasses any modifications within the scope of the appended claims.

What I claim is:

1. A decoupling sheet as a support for a covering that is to be mounted on a subsurface, comprising:
at least two interconnected layers, including:
a foil-type bottom layer for disposition on the substructure; and
a support layer for receiving the covering, wherein said support layer is disposed upon, and connected to, said bottom layer, further wherein said support layer is comprised of a open-pore, water resistant, and non-deformable foam material to form a foam layer, further wherein apertures are disposed in said foam layer and extend from said bottom layer to an opposite, free surface of said foam layer, and wherein said apertures are distributed over said free surface of said foam layer.

2. A decoupling sheet according to claim 1, wherein said bottom layer is provided with a fine perforation, or wherein said bottom layer (12) is comprised of a waterproof material.

3. A decoupling sheet according to claim 2, wherein said bottom layer is comprised of a sheet of foil having a respective sheet of fleece disposed on opposite sides thereof.

4. A decoupling sheet according to claim 2, wherein said bottom layer is comprised of a sheet of paper.

5. A decoupling sheet according to claim 1, wherein said foam layer is extruded from said foam material.

6. A decoupling sheet according to claim 1, wherein said foam material of said foam layer is selected from the group consisting of polypropylene, polyethylene, polystyrene and polyurethane.

7. A decoupling sheet according to claim 5, wherein said bottom layer is applied to one side of said foam layer in a single operation at the same time as said foam layer is extruded.
